(19) United States
(12) Patent Application Publication
(10) Pub. No.: US 2024/0013046 A1
(43) Pub. Date: Jan. 11, 2024

(54) APPARATUS, METHOD AND COMPUTER PROGRAM PRODUCT FOR LEARNED VIDEO CODING FOR MACHINE

(71) Applicant: Nokia Technologies Oy, Espoo (FI)

(72) Inventors: Nam LE, Tampere (FI); Francesco CRICRÌ, Tampere (FI); Honglei ZHANG, Tampere (FI); Hamed REZAZADEGAN TAVAKOLI, Espoo (FI); Ramin GHAZNAVI YOUVALARI, Tampere (FI)

(21) Appl. No.: 18/247,200

(22) PCT Filed: Sep. 2, 2021
(86) PCT No.: PCT/IB2021/058036

§ 371 Date: Mar. 29, 2023

Related U.S. Application Data
(60) Provisional application No. 63/093,867, filed on Oct. 20, 2020.

(51) Int. Cl. G06N 3/08

(52) U.S. Cl. CPC G06N 3/08

(57) ABSTRACT

A method is provided for computing predetermined loss terms based on original data and decoded data; training one or more neural networks of a system by using the predetermined loss terms; updating weights for one or more of other loss terms; and determining trade-offs between predetermined objectives of the system. Corresponding apparatuses and computer program products are also provided.

### SUPPORT STATEMENT

The project leading to this application has received funding from the ECSEL Joint Undertaking (JU) under grant agreement No 783162. The JU receives support from the European Union's Horizon 2020 research and innovation programme and Netherlands, Czech Republic, Finland, Spain, Italy

### TECHNICAL FIELD

The examples and non-limiting embodiments relate generally to multimedia transport and neural networks and, more particularly, to a set of strategies for weighting the loss terms forming training objectives for an end-to-end learned video codec for machines.

### BACKGROUND

It is known to provide standardized formats for exchange of neural networks.

### SUMMARY

An example apparatus includes at least one processor; and at least one non-transitory memory including computer program code; wherein the at least one memory and the computer program code are configured to, with the at least one processor, cause the apparatus at least to perform compute predetermined loss terms based on original data and decoded data; train one or more neural networks of a system by using the predetermined loss terms; update weights for one or more of other loss terms; and determine trade-offs between predetermined objectives of the system.

The apparatus may further include, wherein the predetermined loss terms and other loss terms comprise one or more distortion metrics.

The apparatus may further include, wherein the one or more distortion metrics comprise mean squared error (MSE) losses, a sum of absolute differences (L1 norm), a sum of squared differences (L2 norm), or a multi-scale structural similarity index measure (MS-SSIM).

The apparatus may be further caused to combine one or more metrics with same or different weights.

The apparatus may further include, wherein the one or more neural networks of the system comprises one or more of a neural network encoder, a neural network decoder, or a probability model.

The apparatus may be further caused to set a non-zero weight for the predetermined loss terms; and set a zero weight for the one or more other loss terms.

The apparatus may further include, wherein the one or more other loss terms do not comprise the predetermined loss terms.

The apparatus may further include, wherein the weights for the one or more other losses are changed gradually in order to adapt the one or more neural networks non-abruptly.

The apparatus may further include, wherein the weights for the one or more other losses are changed based on a priority of the one or more other losses.

The apparatus may further include, wherein to change the weights of the one or more other losses, the apparatus is further caused to increase the weights of the one or more other losses.

The apparatus may be further caused to decrease a learning rate, wherein the learning rate determines a scaling of weight-updates for the one or more other loss terms.

Another example apparatus includes at least one processor; and at least one non-transitory memory including computer program code; wherein the at least one memory and the computer program code are configured to, with the at least one processor, cause the apparatus at least to perform use a first set of pre-determined losses to dominate a gradient flow at a neural network warm-up phase; ease influence of the first set of pre-determined losses at an end or substantially at the end of the neural network warm-up phase; improve a task performance at the end or substantially at the end of the neural network warm-up phase; stop improving the task performance, after a predetermined time, to decrease a bit rate loss; and gradually increase a weight of the bit rate loss to achieve a pre-determined bit-rate or a pre-determined task performance

The apparatus may be further be caused to assign a tolerance value for a loss variance of each loss term in the first set of pre-determined losses.

The apparatus may be further caused to disable gradients with respect to a first subset of the first set of pre-determined losses; minimize losses in a second subset of the first set of pre-determined losses till a tolerance for the first subset is violated, wherein the first subset and the second subset are disjoint subsets; switch roles of the first subset and the second subset, and repeat the previous steps; and stop repeating when one or more stopping conditions are met.

A yet another apparatus includes at least one processor; and at least one non-transitory memory including computer program code; wherein the at least one memory and the computer program code are configured to, with the at least one processor, cause the apparatus at least to perform: assign a tolerance value for loss variance of loss terms in a first set of pre-determined losses; disable gradients with respect to a first subset of the first set of pre-determined losses; minimize losses in a second subset of the first set of pre-determined losses till a tolerance for the first subset is violated, wherein the first subset and the second subset are disjoint subsets; switch roles of the first subset and the second subset, and repeat the previous steps; and stop repeating when one or more stopping conditions are met.

A still another apparatus includes at least one processor; and at least one non-transitory memory including computer program code; wherein the at least one memory and the computer program code are configured to, with the at least one processor, cause the apparatus at least to perform extract low level and intermediate level features from an original data and a decoded data; compute one or more distortion metrics between the low level and intermediate level features from the original data and the decoded data; generate a perceptual loss based on a linear combination of the one or more distortion metrics; use the perceptual loss as a proxy for a task loss; update an initial version of a latent tensor to minimize weighted sum of the perceptual loss between the original data and the decoded data.

The apparatus may be further caused to output the initial version of the latent tensor, wherein the initial version of the latent tensor is an encoded representation of the original data.

The apparatus may further include, wherein the initial version of the latent tensor is randomly initialized.

The apparatus may be further caused to update the initial version of the latent tensor to minimize one or more of a weighted sum of a rate loss, a mean squared error loss, or a multi-scale structural similarity index measure.

An example method includes computing predetermined loss terms based on original data and decoded data; training one or more neural networks of a system by using the predetermined loss terms; updating weights for one or more of other loss terms; and determining trade-offs between predetermined objectives of the system.

The method may further include, wherein the predetermined loss terms and other loss terms comprise one or more distortion metrics.

The method may further include, wherein the one or more distortion metrics comprise mean squared error (MSE) losses, a sum of absolute differences (L1 norm), a sum of squared differences (L2 norm), or a multi-scale structural similarity index measure (MS-SSIM).

The method may further include combining one or more metrics with same or different weights.

The method may further include, wherein the one or more neural networks of the system comprises one or more of a neural network encoder, a neural network decoder, or a probability model.

The method may further include setting a non-zero weight for the predetermined loss terms; and setting a zero weight for the one or more other loss terms.

The method may further include, wherein the one or more other loss terms do not comprise the predetermined loss terms.

The method may further include, wherein the weights for the one or more other losses are changed gradually in order to adapt the one or more neural networks non-abruptly.

The method may further include, wherein the weights for the one or more other losses are changed based on a priority of the one or more other losses.

The method may further include, wherein to change the weights of the one or more other losses, the apparatus is further caused to increase the weights of the one or more other losses.

The method may further include decreasing a learning rate, wherein the learning rate determines a scaling of weight-updates for the one or more other loss terms.

Another example method includes using a first set of pre-determined losses to dominate a gradient flow at a neural network warm-up phase; easing influence of the first set of pre-determined losses at an end or substantially at the end of the neural network warm-up phase; improving a task performance at the end or substantially at the end of the neural network warm-up phase; stopping improving the task performance, after a predetermined time, to decrease a bit rate loss; and gradually increasing a weight of the bit rate loss to achieve a pre-determined bit-rate or a pre-determined task performance.

The method may further include assigning a tolerance value for loss variance of each loss term in the first set of pre-determined losses.

The method may further include disabling gradients with respect to a first subset of the first set of pre-determined losses; minimizing losses in a second subset of the first set of pre-determined losses till a tolerance for the first subset is violated, wherein the first subset and the second subset are disjoint subsets; switching roles of the first subset and the second subset, and repeat the previous steps; and stop repeating when one or more a stopping conditions are met.

A yet another method includes assigning a tolerance value for loss variance of loss terms in a first set of pre-determined losses; disabling gradients with respect to a first subset of the first set of pre-determined losses; minimizing losses in a second subset of the first set of pre-determined losses till a tolerance for the first subset is violated, wherein the first subset and the second subset are disjoint subsets; switching roles of the first subset and the second subset, and repeat the previous steps; and stop repeating when one or more stopping conditions are met.

A still another method includes extracting low level and intermediate level features from an original data and a decoded data; computing one or more distortion metrics between the low level and intermediate level features from the original data and the decoded data; generating a perceptual loss based on a linear combination of the one or more distortion metrics; using the perceptual loss as a proxy for a task loss; and updating an initial version of a latent tensor to minimize weighted sum of the perceptual loss between the original data and the decoded data.

The method may further include outputting the initial version of the latent tensor, wherein the initial version of the latent tensor is an encoded representation of the original data.

The method may further include, wherein the initial version of the latent tensor is randomly initialized.

The method may further include updating the initial version of the latent tensor to minimize one or more of a weighted sum of a rate loss, a mean squared error loss, or a multi-scale structural similarity index measure.

An example computer readable medium includes program instructions for performing at least the following compute predetermined loss terms based on original data and decoded data; train one or more neural networks of a system by using the predetermined loss terms; update weights for one or more of other loss terms; and determine trade-offs between predetermined objectives of the system.

The computer readable may further include, wherein the computer readable comprises a non-transitory computer readable medium.

Another example computer readable medium includes program instructions for performing at least the following: use a first set of pre-determined losses to dominate a gradient flow at a neural network warm-up phase; ease influence of the first set of pre-determined losses at an end or substantially at the end of the neural network warm-up phase; improve a task performance at the end or substantially at the end of the neural network warm-up phase; stop improving the task performance, after a predetermined time, to decrease a bit rate loss; and gradually increase a weight of the bit rate loss to achieve a pre-determined bit-rate or a pre-determined task performance.

The computer readable medium may further include, wherein the computer readable comprises a non-transitory computer readable medium.

A yet another computer readable medium includes program instructions for performing at least the following: assign a tolerance value for loss variance of loss terms in a first set of pre-determined losses; disable gradients with respect to a first subset of the first set of pre-determined losses; minimize losses in a second subset of the first set of pre-determined losses till a tolerance for the first subset is violated, wherein the first subset and the second subset are disjoint subsets; switch roles first subset and the second subset, and repeat the previous steps; and stop repeating when one or more stopping conditions are met.

The computer readable medium may further include, wherein the computer readable comprises a non-transitory computer readable medium.

A still another computer readable medium includes program instructions for performing at least the following: extract low level and intermediate level features from an original data and a decoded data; compute one or more distortion metrics between the low level and intermediate level features from the original data and the decoded data; generate a perceptual loss based on a linear combination of the one or more distortion metrics; use the perceptual loss as a proxy for a task loss; update a an initial version of a latent tensor to minimize weighted sum of the perceptual loss between the original data and the decoded data.

In some embodiments, the perceptual loss comprises feature distortion, for example, a distortion metric computed on the features extracted from an original data and a decoded data.

The computer readable medium may further include, wherein the computer readable comprises a non-transitory computer readable medium.

### BRIEF DESCRIPTION OF THE DRAWINGS

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 shows schematically a block chart of an encoder on a general level.

FIG. 5 is a block diagram showing the interface between an encoder and a decoder in accordance with the examples described herein.

FIG. 6 illustrates a system configured to support streaming of media data from a source to a client device;

FIG. 7 is a block diagram of an apparatus that may be specifically configured in accordance with an example embodiment.

FIG. 8 illustrates a pipeline of video coding for machines (VCM), in accordance of an embodiment.

FIG. 9 illustrates an example of an end-to-end learned approach, in accordance with an embodiment.

FIG. 10 illustrates an example of how the end-to-end learned system may be trained, in accordance with an embodiment.

FIG. 11 illustrates the stabilization effect of having MSE as a contributing loss term on 3 different example.

FIG. 12 illustrates an example of codec targeting both machine consumption and human consumption, in accordance with an embodiment.

FIG. 13 illustrates an example proposed weighting strategy for the task of image segmentation, in accordance with an embodiment.

FIG. 14 illustrates a loss weighting strategy, for the task of image segmentation, in accordance with another embodiment.

FIG. 15 illustrates the rate-distortion performance comparison, in accordance with an embodiment.

FIG. 16 illustrates inference-time optimization in video coding for machine, in accordance with an embodiment.

FIG. 17 is an example apparatus configured to implement a set of strategies for weighting the loss terms forming training objectives for an end-to-end learned video codec for machines, in accordance with an embodiment.

FIG. 18 is an example method to implement a set of strategies for weighting the loss terms forming training objectives for an end-to-end learned video codec for machines, in accordance with an embodiment.

FIG. 19 is an example method to implement a set of strategies for weighting the loss terms forming training objectives for an end-to-end learned video codec for machines, in accordance with another embodiment.

FIG. 20 is an example method to implement a loss calibration strategy to balance losses, in accordance with an embodiment.

FIG. 21 is an example method to implement inference-time optimization, in accordance with an embodiment.

FIG. 22 is a block diagram of one possible and non-limiting system in which the example embodiments may be practiced.

### DETAILED DESCRIPTION OF EXAMPLE EMBODIMENTS

The following acronyms and abbreviations that may be found in the specification and/or the drawing figures are defined as follows:
3GP 3GPP file format
3GPP 3rd Generation Partnership Project
3GPP TS 3GPP technical specification
4CC four character code
4G fourth generation of broadband cellular
   network technology
5fifth generation cellular network technology 5GC 5G core network
ACC accuracy
AI artificial intelligence
AIoT AI-enabled IoT
a.k.a. also known as
AMF access and mobility management function
AVC advanced video coding
CABAC context-adaptive binary arithmetic coding
CDMA code-division multiple access
CE core experiment
CU central unit
DASH dynamic adaptive streaming over HTTP
DCT discrete cosine transform
DSP digital signal processor
DU distributed unit
eNB (or eNodeB) evolved Node B (for example, an LTE base
   station)
EN-DC E-UTRA-NR dual connectivity
en-gNB or En-gNB node providing NR user plane and control
   plane protocol terminations towards the UE,
   and acting as secondary node in EN-DC
E-UTRA evolved universal terrestrial radio access, for
   example, the LTE radio access technology
FDMA frequency division multiple access
f(n) fixed-pattern bit string using n bits written
   (from left to right) with the left bit first.
F1 or F1-C interface between CU and DU control interface
   gNB (or gNodeB) base station for 5G/NR, for example, a node
   providing NR user plane and control plane
   protocol terminations towards the UE, and
   connected via the NG interface to the 5GC
GSM Global System for Mobile communications
H.222.0 MPEG-2 Systems is formally known as
   ISO/IEC 13818-1 and as ITU-T Rec. H.222.0
H.26x family of video coding standards in the domain
   of the ITU-T
HLS high level syntax
IBC intra block copy
ID identifier
IEC International Electrotechnical Commission
IEEE Institute of Electrical and Electronics
   Engineers
I/F
IMD integrated messaging device
IMS instant messaging service
IoT internet of things
IP internet protocol
ISO International Organization for Standardization
ISOBMFF ISO base media file format
ITU International Telecommunication Union
ITU-T ITU Telecommunication Standardization
   Sector
LTE long-term evolution
LZMA Lempel-Ziv-Markov chain compression
LZMA2 simple container format that can include both
   uncompressed data and LZMA data
LZO Lempel-Ziv-Oberhumer compression
LZW Lempel-Ziv-Welch compression
MAC medium access control
mdat MediaDataBox
MME mobility management entity
MMS multimedia messaging service
moov MovieBox
MP4 file format for MPEG-4 Part 14 files
MPEG moving picture experts group
MPEG-2 H.222/H.262 as defined by the ITU
MPEG-4 audio and video coding standard for ISO/IEC
   14496
MSB most significant bit
MSE mean squared error
NAL network abstraction layer
NDU NN compressed data unit
ng or NG new generation
ng-eNB or NG-eNB new generation eNB
NN neural network
NNEF neural network exchange format
NNR neural network representation
NR new radio (5G radio)
N/W or NW network
ONNX Open Neural Network eXchange
PB protocol buffers
PC personal computer
PDA personal digital assistant
PDCP packet data convergence protocol
PHY physical layer
PID packet identifier
PLC power line communication
PSNR peak signal-to-noise ratio
RAM random access memory
RAN radio access network
RFC request for comments
RFID radio frequency identification
RLC radio link control
RRC radio resource control
RRH remote radio head
RU radio unit
Rx receiver
SDAP service data adaptation protocol
SGW serving gateway
SMF session management function
SMS short messaging service
st(v) null-terminated string encoded as UTF-8
   characters as specified in ISO/IEC 10646
SVC scalable video coding
S1 interface between eNodeBs and the EPC
TCP-IP transmission control protocol-internet protocol
TDMA time divisional multiple access
trak TrackBox
TS transport stream
TV television
Tx transmitter
UE user equipment
ue(v) unsigned integer Exp-Golomb-coded syntax
   element with the left bit first
UICC Universal Integrated Circuit Card
UMTS Universal Mobile Telecommunications System
u(n) unsigned integer using n bits
UPF user plane function
URI uniform resource identifier
URL uniform resource locator
UTF-8 8-bit Unicode Transformation Format
VCM video coding for machine
WLAN wireless local area network
X2 interconnecting interface between two
   eNodeBs in LTE network
Xn interface between two NG-RAN nodes

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the invention. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment in order to provide learned video coding for machines.

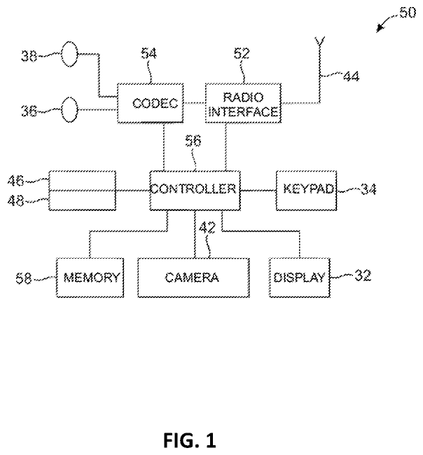

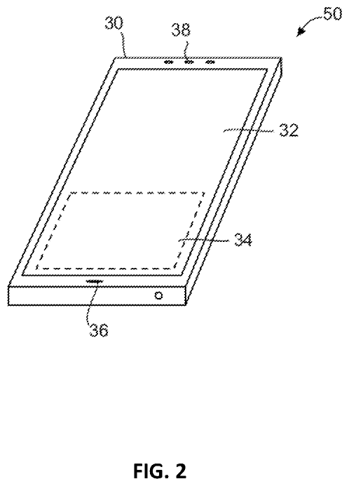

The following describes in detail suitable apparatus and possible mechanisms for a video/image encoding process according to embodiments. In this regard reference is first made to FIG. 1 and FIG. 2, where FIG. 1 shows an example block diagram of an apparatus 50. The apparatus may be an Internet of Things (IoT) apparatus configured to perform various functions, for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 will be explained next.

The apparatus 50 may for example be a mobile terminal or user equipment of a wireless communication system, a sensor device, a tag, or a lower power device. However, it would be appreciated that embodiments of the examples described herein may be implemented within any electronic device or apparatus which may process data by neural networks.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display media or multimedia content, for example, an image or video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the examples described herein may be any one of: an earpiece 38, speaker, or an analogue audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera 42 capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the examples described herein may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The apparatus 50 may comprise a camera capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

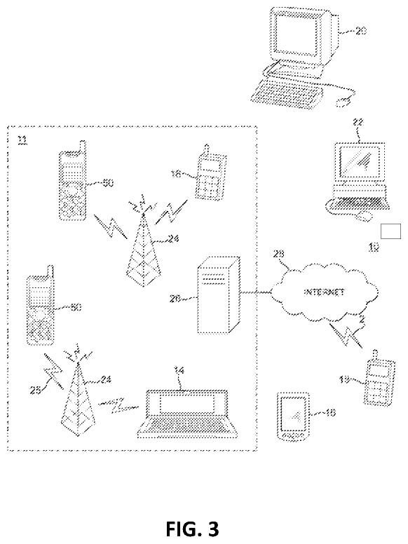

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA, LTE, 4G, 5G network, and the like), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; for example, a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, and the like, to be included the Internet of Things (IoT). In order to utilize Internet IoT devices are provided with an IP address as a unique identifier. IoT devices may be provided with a radio transmitter, such as WLAN or Bluetooth transmitter or a RFID tag. Alternatively, IoT devices may have access to an IP-based network via a wired network, such as an Ethernet-based network or a power-line connection (PLC).

An MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Available media file format standards include ISO base media file format (ISO/IEC 14496-12, which may be abbreviated ISOBMFF) and file format for NAL unit structured video (ISO/IEC 14496-15), which derives from the ISOBMFF.

Video codec consists of an encoder that transforms the input video into a compressed representation suited for storage/transmission and a decoder that can decompress the compressed video representation back into a viewable form. A video encoder and/or a video decoder may also be separate from each other, for example, need not form a codec. Typically encoder discards some information in the original video sequence in order to represent the video in a more compact form (that is, at lower bitrate).

Typical hybrid video encoders, for example many encoder implementations of ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, for example, the difference between the predicted block of pixels and the original block of pixels, is coded. This is typically done by transforming the difference in pixel values using a specified transform (for example, Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC; a.k.a. intra-block-copy prediction and current picture referencing), prediction is applied similarly to temporal prediction but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process than temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, for example, either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

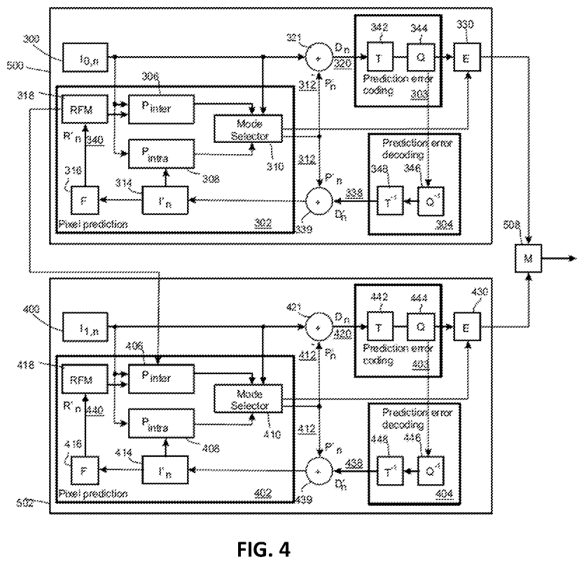

FIG. 4 shows a block diagram of a general structure of a video encoder. FIG. 4 presents an encoder for two layers, but it would be appreciated that presented encoder could be similarly extended to encode more than two layers. FIG. 4 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406, an intra-predictor 308, 408, a mode selector 310, 410, a filter 316, 416, and a reference frame memory 318, 418. The pixel predictor 302 of the first encoder section 500 receives base layer pictures 300 of a video stream to be encoded at both the inter-predictor 306 (which determines the difference between the image and a motion compensated reference frame) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 502 receives enhancement layer picture(s) 400 of a video stream to be encoded at both the inter-predictor 406 (which determines the difference between the image and a motion compensated reference frame) and the intra-predictor 408 (which determines a prediction for an image block based only on the already processed parts of current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 which is input to the prediction error encoder 303, 403.

The pixel predictor 302, 402 further receives from a preliminary reconstructor 339, 439 the combination of the prediction representation of the image block 312, 412 and the output 338, 438 of the prediction error decoder 304, 404. The preliminary reconstructed image 314, 414 may be passed to the intra-predictor 308, 408 and to the filter 316, 416. The filter 316, 416 receiving the preliminary representation may filter the preliminary representation and output a final reconstructed image 340, 440 which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be source for inter-layer sample prediction and/or inter-layer motion information prediction of the enhancement layer according to some embodiments, the reference frame memory 318 may also be connected to the inter-predictor 406 to be used as the reference image against which a future enhancement layer pictures 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 500 may be provided to the second encoder section 502 subject to the base layer being selected and indicated to be source for predicting the filtering parameters of the enhancement layer according to some embodiments.

The prediction error encoder 303, 403 comprises a transform unit 342, 442 and a quantizer 344, 444. The transform unit 342, 442 transforms the first prediction error signal 320, 420 to a transform domain. The transform is, for example, the DCT transform. The quantizer 344, 444 quantizes the transform domain signal, for example, the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder may be considered to comprise a dequantizer 346, 446, which dequantizes the quantized coefficient values, for example, DCT coefficients, to reconstruct the transform signal and an inverse transformation unit 348, 448, which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 receives the output of the prediction error encoder 303, 403 and may perform a suitable entropy encoding/variable length encoding on the signal to provide error detection and correction capability. The outputs of the entropy encoders 330, 430 may be inserted into a bitstream, for example, by a multiplexer 508.

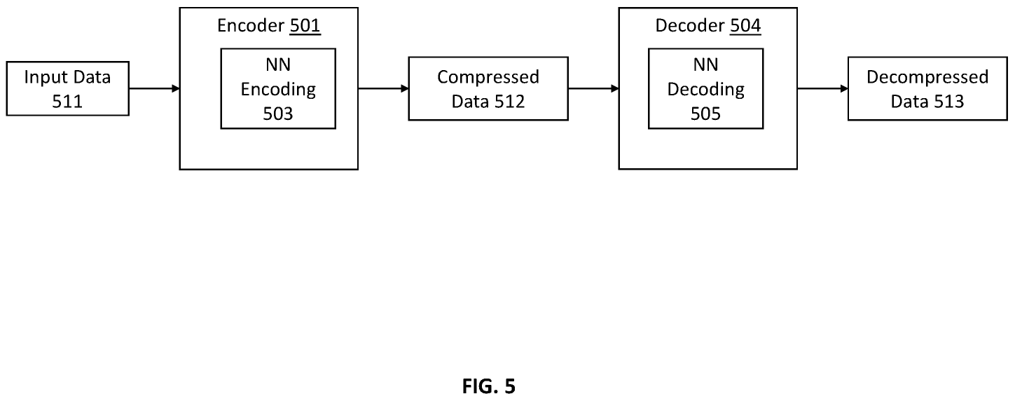

FIG. 5 is a block diagram showing the interface between an encoder 501 implementing neural network encoding 503, and a decoder 504 implementing neural network decoding 505 in accordance with the examples described herein. The encoder 501 may embody a device, software method or hardware circuit. The encoder 501 has the goal of compressing input data 511 (for example, an input video) to compressed data 512 (for example, a bitstream) such that the bitrate is minimized and the accuracy of an analysis or processing algorithm is maximized To this end, the encoder 501 uses an encoder or compression algorithm, for example to perform neural network encoding 503.

The general analysis or processing algorithm may be part of the decoder 504. The decoder 504 uses a decoder or decompression algorithm, for example to perform the neural network decoding 505 to decode the compressed data 512 (for example, compressed video) which was encoded by the encoder 501. The decoder 504 produces decompressed data 513 (for example, reconstructed data).

The encoder 501 and decoder 504 may be entities implementing an abstraction, may be separate entities or the same entities, or may be part of the same physical device.

The analysis/processing algorithm may be any algorithm, traditional or learned from data. In the case of an algorithm which is learned from data, it is assumed that this algorithm can be modified or updated, for example using optimization via gradient descent. One example of the learned algorithm is a neural network.

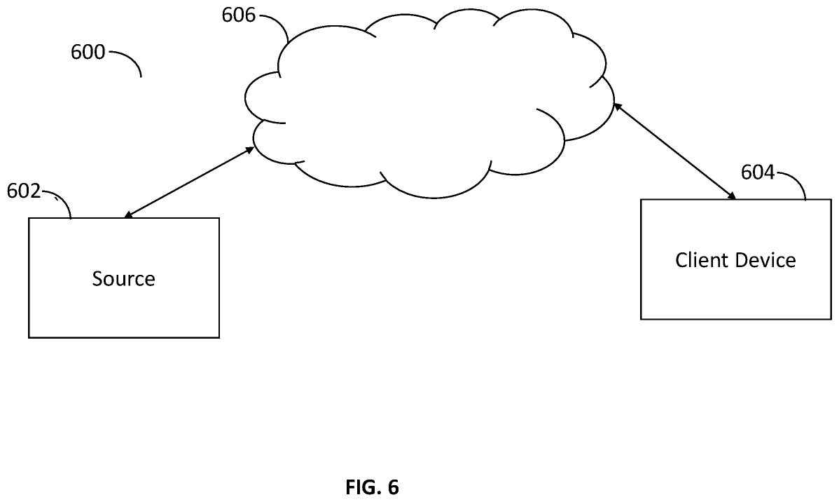

The method and apparatus of an example embodiment may be utilized in a wide variety of systems, including systems that rely upon the compression and decompression of media data and possibly also the associated metadata. In one embodiment, however, the method and apparatus are configured to compress the media data and associated metadata streamed from a source via a content delivery network to a client device, at which point the compressed media data and associated metadata is decompressed or otherwise processed. In this regard, FIG. 6 depicts an example of such a system 600 that includes a source 602 of media data and associated metadata. The source may be, in one embodiment, a server. However, the source may be embodied in other manners if so desired. The source is configured to stream boxes containing the media data and associated metadata to a client device 604. The client device may be embodied by a media player, a multi media system, a video system, a smart phone, a mobile telephone or other user equipment, a personal computer, a tablet computer or any other computing device configured to receive and decompress the media data and process associated metadata. In the illustrated embodiment, boxes of media data and boxes of metadata are streamed via a network 606, such as any of a wide variety of types of wireless networks and/or wireline networks. The client device is configured to receive structured information containing media, metadata and any other relevant representation of information containing the media and the metadata and to decompress the media data and process the associated metadata (e.g. for proper playback timing of decompressed media data).

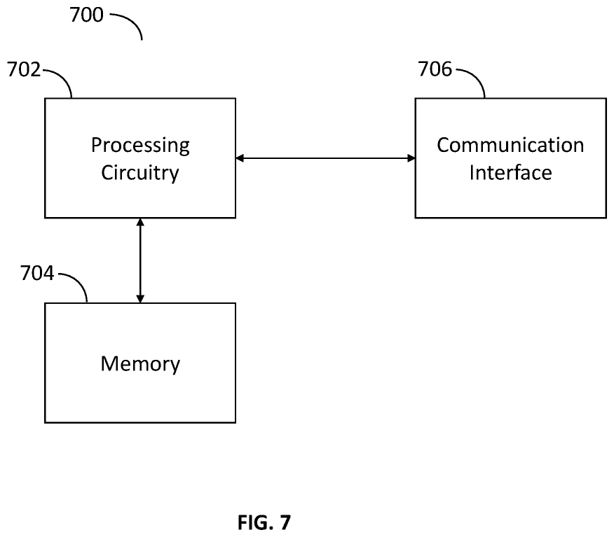

An apparatus 700 is provided in accordance with an example embodiment as shown in FIG. 7. In one embodiment, the apparatus of FIG. 7 may be embodied by a source 602, such as a file writer which, in turn, may be embodied by a server, that is configured to stream a compressed representation of the media data and associated metadata. In an alternative embodiment, the apparatus may be embodied by the client device 604, such as a file reader which may be embodied, for example, by any of the various computing devices described above. In either of these embodiments and as shown in FIG. 7, the apparatus of an example embodiment includes, is associated with or is in communication with processing circuitry 702, one or more memory devices 704, a communication interface 706 and optionally a user interface.

The processing circuitry 702 may be in communication with the memory device 704 via a bus for passing information among components of the apparatus 700. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 700 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processing circuitry 702 may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 32 may be configured to execute instructions stored in the memory device 34 or otherwise accessible to the processing circuitry. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processing circuitry to perform the algorithms and/or operations described herein when the instructions are executed. However, in some cases, the processing circuitry may be a processor of a specific device (e.g., an image or video processing system) configured to employ an embodiment of the invention by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 706 may be any means such as a device or circuitry embodied in either hardware or a combination of hardware and software that is configured to receive and/or transmit data, including video bitstreams. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, the apparatus 700 may optionally include a user interface that may, in turn, be in communication with the processing circuitry 702 to provide output to a user, such as by outputting an encoded video bitstream and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processing circuitry may comprise user interface circuitry configured to control at least some functions of one or more user interface elements such as a display and, in some embodiments, a speaker, ringer, microphone and/or the like. The processing circuitry and/or user interface circuitry comprising the processing circuitry may be configured to control one or more functions of one or more user interface elements through computer program instructions (e.g., software and/or firmware) stored on a memory accessible to the processing circuitry (e.g., memory device, and/or the like).

Fundamentals of Neural Networks

A neural network (NN) is a computation graph consisting of several layers of computation. Each layer consists of one or more units, where each unit performs an elementary computation. A unit is connected to one or more other units, and a connection may be associated with a weight. The weight may be used for scaling the signal passing through an associated connection. Weights are learnable parameters, for example, values which can be learned from training data. There may be other learnable parameters, such as those of batch-normalization layers.

Two of the most widely used architectures for neural networks are feed-forward and recurrent architectures. Feed-forward neural networks are such that there is no feedback loop, each layer takes input from one or more of the layers before and provides its output as the input for one or more of the subsequent layers. Also, units inside a certain layer take input from units in one or more of preceding layers and provide output to one or more of following layers.

Initial layers, those close to the input data, extract semantically low-level features, for example, edges and textures in images, and intermediate and final layers extract more high-level features. After the feature extraction layers there may be one or more layers performing a certain task, for example, classification, semantic segmentation, object detection, denoising, style transfer, super-resolution, and the like. In recurrent neural networks, there is a feedback loop, so that the neural network becomes stateful, for example, it is able to memorize information or a state.

Neural networks are being utilized in an ever-increasing number of applications for many different types of devices, for example, mobile phones, chat bots, IoT devices, smart cars, voice assistants, and the like. Some of these applications include, but are not limited to, image and video analysis and processing, social media data analysis, device usage data analysis, and the like.

One of the properties of neural networks, and other machine learning tools, is that they are able to learn properties from input data, either in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, and the like. In recent deep learning techniques, training is an iterative process, where at each iteration the algorithm modifies the weights of the neural network to make a gradual improvement in the network's output, for example, gradually decrease the loss.

In various embodiments, terms ‘model’, ‘neural network’, ‘neural net’ and ‘network may be used interchangeably, and also the weights of neural networks are sometimes referred to as learnable parameters or simply as parameters.

Training a neural network is an optimization process, but the final goal is different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, for example, data which was not used for training the model. This is usually referred to as generalization. In practice, data is usually split into at least two sets, the training set and the validation set. The training set is used for training the network, for example, to modify its learnable parameters in order to minimize the loss. The validation set is used for checking the performance of the network on data which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set, but performs poorly on a set not used for tuning or training its parameters.

Lately, neural networks have been used for compressing and de-compressing data such as images. The most widely used architecture for such task is the auto-encoder, which is a neural network consisting of two parts: a neural encoder and a neural decoder. In various embodiments, these neural encoder and neural decoder may be referred to as encoder and decoder, even though these refer to algorithms which are learned from data instead of being tuned manually. The encoder takes an image as an input and produces a code, to represent the input image, which requires less bits than the input image. This code may have obtained by a binarization or quantization process after the encoder. The decoder takes in this code and reconstructs the image which was input to the encoder.

Such encoder and decoder are usually trained to minimize a combination of bitrate and distortion, where the distortion is usually mean squared error (MSE), peak signal to noise ratio (PSNR), structural similarity (SSIM) index, or similar metrics. These distortion metrics are meant to be inversely proportional to the human visual perception quality.

Fundamentals of Video/Image Coding

Video codec consists of an encoder that transforms the input video into a compressed representation suited for storage/transmission and a decoder that can decompress the compressed video representation back into a viewable form. Typically, an encoder discards some information in the original video sequence in order to represent the video in a more compact form, for example, at lower bitrate.

Typical hybrid video codecs, for example ITU-T H.263 and H.264, encode the video information in two phases. Firstly, pixel values in a certain picture area (or ‘block’) are predicted. In an example, the pixel values may be predicted by using motion compensation algorithm. This prediction technique includes finding and indicating an area in one of the previously coded video frames that corresponds closely to the block being coded. In other example, the pixel values may be predicted by using spatial prediction techniques. This prediction technique uses the pixel values around the block to be coded in a specified manner. Secondly, the prediction error, for example, the difference between the predicted block of pixels and the original block of pixels is coded. This is typically done by transforming the difference in pixel values using a specified transform, for example, discrete cosine transform (DCT) or a variant of it; quantizing the coefficients; and entropy coding the quantized coefficients. By varying the fidelity of the quantization process, encoder can control the balance between the accuracy of the pixel representation, for example, picture quality and size of the resulting coded video representation, for example, file size or transmission bitrate.

Inter prediction, which may also be referred to as temporal prediction, motion compensation, or motion-compensated prediction, exploits temporal redundancy. In inter prediction the sources of prediction are previously decoded pictures.

Intra prediction utilizes the fact that adjacent pixels within the same picture are likely to be correlated. Intra prediction can be performed in spatial or transform domain, for example, either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction techniques similar to the encoder to form a predicted representation of the pixel blocks. For example, using the motion or spatial information created by the encoder and stored in the compressed representation and prediction error decoding, which is inverse operation of the prediction error coding recovering the quantized prediction error signal in spatial pixel domain After applying prediction and prediction error decoding techniques the decoder sums up the prediction and prediction error signals, for example, pixel values to form the output video frame. The decoder and encoder can also apply additional filtering techniques to improve the quality of the output video before passing it for display and/or storing it as prediction reference for the forthcoming frames in the video sequence.

In typical video codecs the motion information is indicated with motion vectors associated with each motion compensated image block. Each of these motion vectors represents the displacement of the image block in the picture to be coded in the encoder side or decoded in the decoder side and the prediction source block in one of the previously coded or decoded pictures. In order to represent motion vectors efficiently those are typically coded differentially with respect to block specific predicted motion vectors. In typical video codecs the predicted motion vectors are created in a predefined way, for example, calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

In typical video codecs, the prediction residual after motion compensation is first transformed with a transform kernel, for example, DCT and then coded. The reason for this is that often there still exists some correlation among the residual and transform can in many cases help reduce this correlation and provide more efficient coding.

Typical video encoders utilize Lagrangian cost functions to find optimal coding modes, for example, the desired Macroblock mode and associated motion vectors. This kind of cost function uses a weighting factor to tie together the exact or estimated image distortion due to lossy coding methods and the exact or estimated amount of information that is required to represent the pixel values in an image area:

C=D+λR equation 1

In equation 1, C is the Lagrangian cost to be minimized, D is the image distortion, for example, mean squared error with the mode and motion vectors considered, and R is the number of bits needed to represent the required data to reconstruct the image block in the decoder including the amount of data to represent the candidate motion vectors.

Video Coding for Machines (VCM)

Reducing the distortion in image and video compression is often intended to increase human perceptual quality, as humans are considered to be the end users, e.g. consuming or watching the decoded image. Recently, with the advent of machine learning, especially deep learning, there is a rising number of machines (e.g., autonomous agents) that analyze data independently from humans and may even take decisions based on the analysis results without human intervention. Examples of such analysis are object detection, scene classification, semantic segmentation, video event detection, anomaly detection, pedestrian tracking, and the like. Example use cases and applications are self-driving cars, video surveillance cameras and public safety, smart sensor networks, smart TV and smart advertisement, person re-identification, smart traffic monitoring, drones, and the like. Accordingly, when decoded data is consumed by machines, a quality metric may be defined, which is different form a quality metric for human perceptual quality, when considering media compression in inter-machine communications. Also, dedicated algorithms for compressing and decompressing data for machine consumption are likely to be different than those for compressing and decompressing data for human consumption. The set of tools and concepts for compressing and decompressing data for machine consumption is referred to here as Video Coding for Machines.

It is likely that the receiver-side device has multiple ‘machines’ or neural networks (NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

In various embodiments, machine and neural network may be referred interchangeably, and may mean to include, any process or algorithm (e.g. learned or not from data) which analyzes or processes data for a certain task. Following paragraphs may specify in further details other assumptions made regarding the machines considered in various embodiments of the invention.

Also, term ‘receiver-side’ or ‘decoder-side’ refers to a physical or abstract entity or device which contains one or more machines, circuits or algorithms; and runs these one or more machines on some encoded and eventually decoded video representation which is encoded by another physical or abstract entity or device, for example, the ‘encoder-side device’.

The encoded video data may be stored into a memory device, for example as a file. The stored file may later be provided to another device.

Alternatively, the encoded video data may be streamed from one device to another.

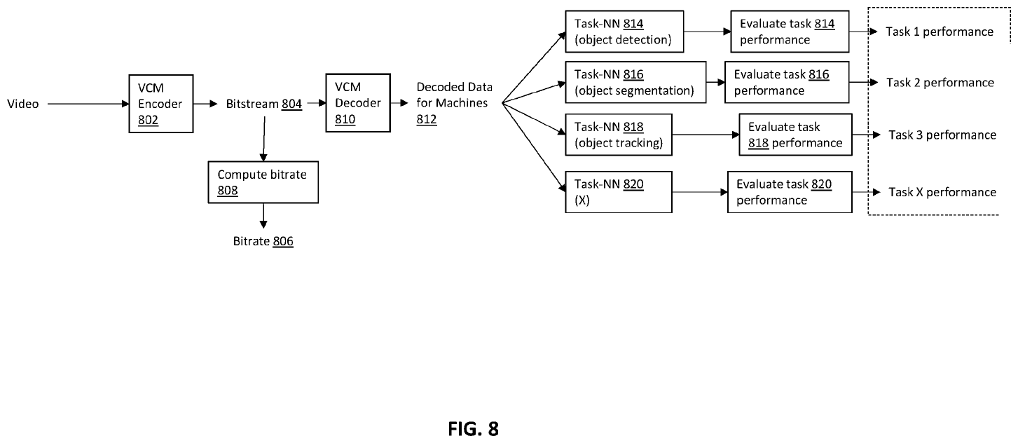

FIG. 8 illustrates a pipeline of video coding for machines (VCM), in accordance of an embodiment. A VCM encoder 802 encodes the input video into a bitstream 804. A bitrate 806 may be computed 808 from the bitstream 804 in order to evaluate the size of the bitstream 804. A VCM decoder 810 decodes the bitstream 804 output by the VCM encoder 802. An output of the VCM decoder 810 may be referred, for example, as decoded data for machines 812. This data may be considered as the decoded or reconstructed video. However, in some implementations of the pipeline of VCM, the decoded data for machines 812 may not have same or similar characteristics as the original video which was input to the VCM encoder 802. For example, this data may not be easily understandable by a human by simply rendering the data onto a screen. The output of VCM decoder 810 is then input to one or more task neural network. For the sake of illustration, FIG. 8 is shown to include three example task-NNs, task-NN 814 for object detection, task-NN 816 for image segmentation, task-NN 818 for object tracking, and a non-specified, task-NN 820 for performing task X. The goal of VCM is to obtain a low bitrate while guaranteeing that the task-NNs still perform well in terms of the evaluation metric associated to each task.

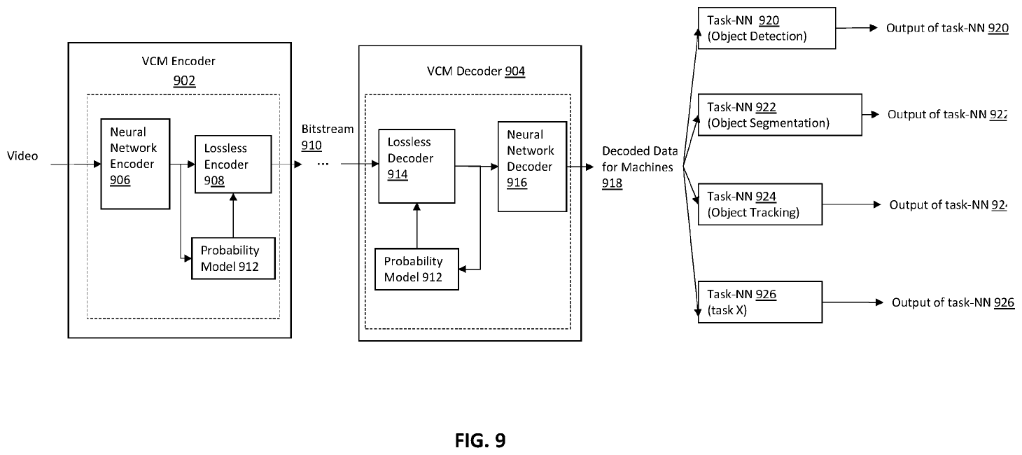

One of the possible approaches to realize video coding for machines is an end-to-end learned approach. FIG. 9 illustrates an example of an end-to-end learned approach, in accordance with an embodiment. In this approach, a VCM encoder 902 and VCM decoder 904 mainly consist of neural networks. The following figure illustrates an example of a pipeline for the end-to-end learned approach. The video is input to a neural network encoder 906. The output of the neural network encoder 906 is input to a lossless encoder 908, such as an arithmetic encoder, which outputs a bitstream 910. The lossless codec may be a probability model 912, both in the lossless encoder 908 and in a lossless decoder 914, which predicts the probability of the next symbol to be encoded and decoded. The probability model 912 may also be learned, for example it may be a neural network. At a decoder-side, the bitstream 910 is input to the lossless decoder 914, such as an arithmetic decoder, whose output is input to a neural network decoder 916. The output of the neural network decoder 916 is the decoded data for machines 918, that may be input to one or more task-NNs, task-NN 920 for object detection, task-NN 922 for image segmentation, task-NN 924 for object tracking, and a non-specified, task-NN 826 for performing task X.

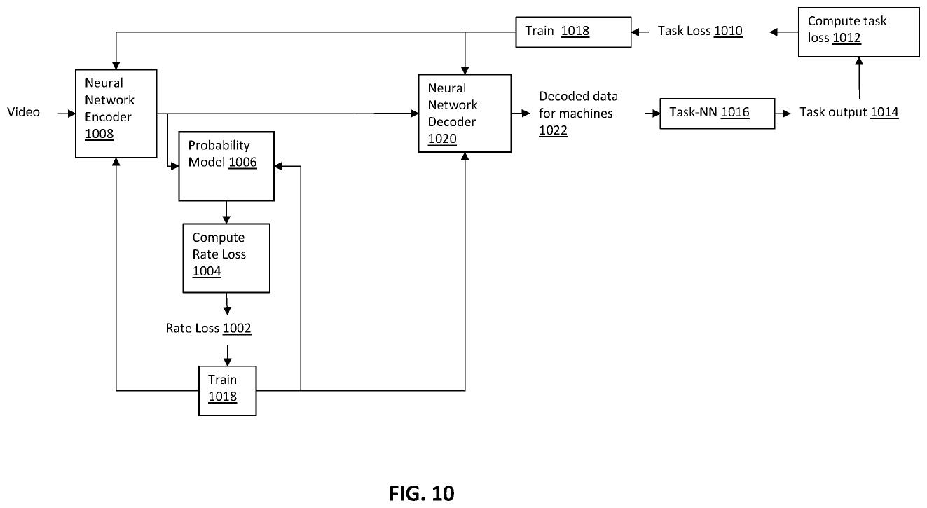

FIG. 10 illustrates an example of how the end-to-end learned system may be trained, in accordance with an embodiment. For the sake of simplicity, only one task-NN is illustrated. However, it may be understood that multiple task-NNs may be similarly used in the training process. A rate loss 1002 may be computed 1004 from the output of a probability model 1006. The rate loss 1002 provides an approximation of the bitrate required to encode the input video data, for example, by a neural network encoder 1008. A task loss 1010 may be computed 1012 from a task output 1014 of a task-NN 1016.

The rate loss 1002 and the task loss 1010 may then be used to train 1018 the neural networks used in the system, such as the neural network encoder 1008, probability model, a neural network decoder 1020. An output of the neural network decoder 810 may be referred, for example, as decoded data for machines 1022. Training may be performed by first computing gradients of each loss with respect to the neural networks that are contributing or affecting the computation of that loss. The gradients are then used by an optimization method, such as Adam, for updating the trainable parameters of the neural networks.

Training of the end-to-end learned approach to VCM can be formulated as multi-objective training

Total loss=w1*rate+w2*task_loss,
where w1 and w2 are scalar values, sometimes referred to as weights (but different from the neural networks' weights) or as coefficients.

An example approach consists of predetermining some fixed w1 and w2 values that yield the best results on a validation dataset.

However, using fixed weights may lead to failure of training, as the gradients of one objective are likely to compete with those of the other(s):
Using approximately-equal weights would cause bad gradients for all the objectives
Weighting one loss less than the other(s) eventually produces bad trade-off in favor of the corresponding objective of that loss.

Exhaustive searching for the optimal combinations of weights is time-consuming. Doing that for each target bitrate (rate control) is even more tedious.

Therefore, there is a need for a suitable weighting strategy, which is specific to the problem of video coding for machines.

Another problem exists for the inference stage. The encoder may perform a content-specific optimization in order to improve the rate-distortion performance with respect to the basic rate-distortion performance provided by the offline-trained system. The optimization may consist of finetuning some of the neural networks at encoder side, or optimizing directly the output of the encoder neural network (sometimes referred to as the latent tensor or an initial version of a latent tensor). However, the encoder does not have availability of the task-NN that the decoder-side device will use on the decoded data. Thus, the problem is about what losses should be used for this inference-time optimization at encoder side.

Various embodiments described herein propose an effective strategy for weighting loss terms that form the loss objective used to train an end-to-end learned video codec for machines. Also, an additional embodiment, proposes a strategy to be used at inference time, when the codec is used to compress a given video.

The task networks are normally trained on images/videos; thus they expect input data which ‘looks like’ images/videos (e.g., have similar probability distribution as images/videos). Therefore, in an initial warm-up phase, a mean-squared error loss (MSE) is used to train the system in order to achieve a good base model. Other loss terms are weighted by zero, so that they do not influence initial training. Experiments showed that the MSE influence keeps the training stable.

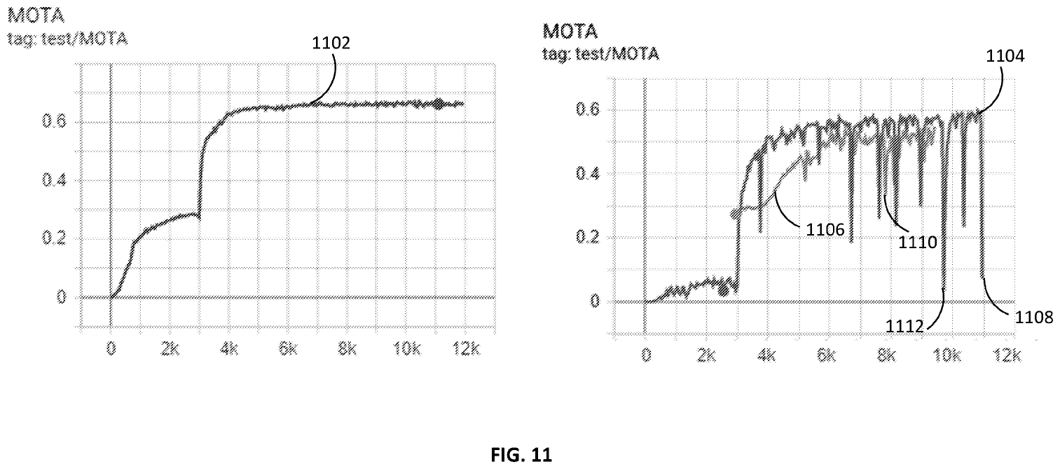

FIG. 11 illustrates the stabilization effect of having MSE as a contributing loss term on 3 different example experiments: 1102, 1104 and 1106. These trainings choose an object Tracking model as the task-NN. The task performance metric is multiple object tracking accuracy (mota), shown on the y-axis and the training iteration number is shown on the x-axis. The training with MSE influence 1102 demonstrates a stable mota curve over iterations, as opposed to 1104 and 1106, where no MSE losses are contributing to the total losses over the course of iteration from 3k to 12k. During this training period, experiments 1104 and 1106 undergo multiple downward peaks in mota performance, e.g. 1108, 1110, and 1112, respectively.

After the warm-up phase, the weight for each objective is changed gradually over training iterations, which gives the network a chance to adapt.

More important objectives will have their respective loss weights increased. Eventually the accumulated gradient flow will be dominated by the gradients coming from these losses, which effectively improves the result with respect to the corresponding objectives.

In an embodiment, importance of an objective depends on the requirements set by the designer of the training process, according to the requirements of the final use case or application for the trained codec, e.g., for low bitrate cases, the most important loss term is the rate loss. For high task performance, the most important loss term(s) is the task(s) loss term(s).

Example, for rate control, in order to achieve a certain target bitrate, the rate-loss would be one of the competing objectives.

The learning-rate, which determines the scaling of weight-updates during training, is decreased overtime to keep the training stable.

An additional embodiment considers the inference stage, for example, when the system is used for compressing a given video. We propose to optimize the output of the encoder (for example, an initial version of a latent tensor) by using a combination of rate loss and a proxy loss for the task loss. The proxy loss is computed based on a pretrained feature extraction neural network. In particular, the proxy loss may be the MSE (or other suitable distortion metric) between the features extracted from the decoded data and the original data that is input to the encoder. Another possibility for the proxy loss is to compute the MSE on features extracted by some of the layers of the encoder neural network, which would act as a feature extractor. Other distortion metrics that can be used instead of MSE are L1 norm, L2 norm, etc.

Preliminaries

An example objective of various embodiments is to obtain a codec which targets the compression and decompression of data which is consumed by machines. The decompressed data may also be consumed by humans, either at the same time or at different times with respect to when the machines consume the decompressed data. The codec may consist of multiple parts, where some parts may be used for compressing or decompressing data for machine consumption, and some other parts may be used for compressing or decompressing data for human consumption.

In some embodiments, it is assumed that at least some of the task-NNs (machines) are models, such as neural networks, for which it is possible to compute gradients of their output with respect to their input. For example, if they are parametric models, this may be possible by computing the gradients of their output first with respect to their internal parameters and then with respect to their input, by using the chain rule for differentiation in mathematics. In the case of neural networks, backpropagation may be used to obtain the gradients of the output of a NN with respect to its input.

Additionally or alternatively, in some embodiments it is assumed that at least some of the steps or components of the encoder and/or decoder used for compressing and/or decompressing data for machine consumption are parametric models, such as neural networks, for which it is possible to compute gradients of their output with respect to their parameters.

An example of codec which mainly consists of neural networks and that targets machine consumption is already illustrated and explained in FIG. 9.

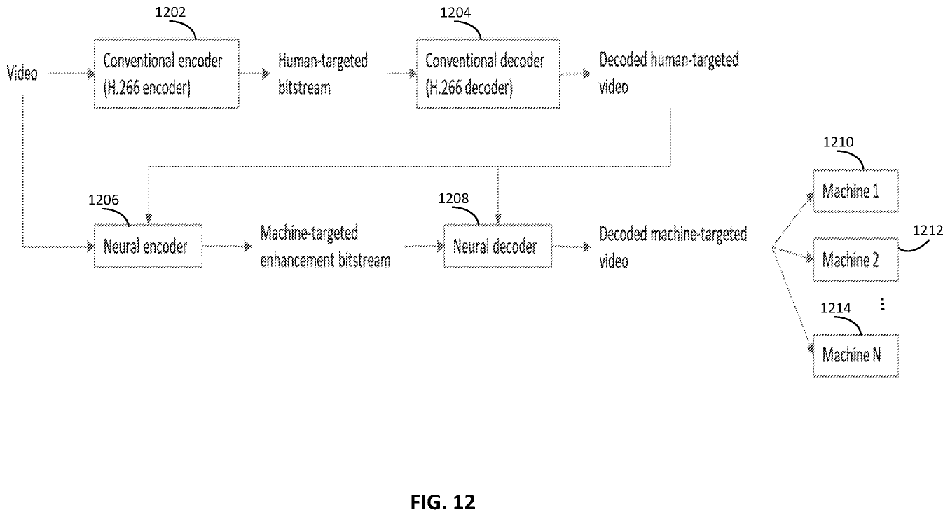

FIG. 12 illustrates an example of codec targeting both machine consumption and human consumption, in accordance with an embodiment. A conventional codec, for example, a conventional encoder 1202 and a conventional decoder 1204 is used to compress/decompress video for human consumption, and an enhancement bitstream is computed by using neural networks, for example, a neural encoder 1206 and decoded machine-targeted video is generated using a neural decoder 1208 for consumption by machines, for example, machine1 1210, machine2 1212, . . . , and machineN 1214.

In an embodiment, both subsystems targeting human consumption and machine consumption are mainly neural networks. The machine-targeted encoder NN may be a neural network, which may act as a feature extractor, for example it may extract machine-targeted spatio-temporal features, or spatio-temporal M-features for short. The output spatio-temporal M-features may then be quantized to a set of discrete values, and entropy encoded, thus obtaining the M-code which is the machine-targeted bitstream. This bitstream may then be entropy decoded.

The output of the entropy decoder may be directly input to the task neural networks, or may first be decoded by a machine-targeted decoder NN, which is another neural network, and the decoded output may be input to the task neural networks. The video is also input to a human-targeted encoder NN which is a neural network. Another input to this neural network may be the quantized or the dequantized spatio-temporal M-features. The output of the human-targeted encoder NN is a set of human-targeted spatio-temporal features, or spatio-temporal H-features for short, which may be quantized and then entropy encoded, thus obtaining the H-code, which is the human-targeted bitstream. At decoder-side, the H-code may be entropy decoded, dequantized, and decoded by a human-targeted decoder NN, which is a neural network. The output of the human-targeted decoder NN is a reconstructed video which may be consumed or watched by humans, for example by rendering on a display or screen. This embodiment also provides an example of a possible implementation for the human-targeted encoder NN, wherein the video is first processed by a set of neural network layers, for example, ‘initial layers of human-targeted encoder NN, then the output of these layers is combined with dequantized spatio-temporal M-features. The combination may be for example a concatenation over one of the axis of the multi-dimensional arrays representing the inputs to be combined. Another example combination may be an element-wise sum. The output of the combination may be input to another set of neural network layers (the ‘Final layers of human-targeted encoder NN;). The output of these layers is the spatio-temporal H-features, which is the output of the human-targeted encoder NN.

In various embodiments, following assumptions are made:
the task-NNs available during training stage are representative of the task-NNs which will be used at inference time, e.g., when the codec will be deployed and used for decompressing data;
the task-NNs available during development stage have been previously trained; and
the data in the domain suitable to be input to the task-NNs available during the inference stage is available during training stage. In some implementations, this data may not be annotated, e.g., may not contain ground-truth labels, and instead labels are derived in other ways, for example as the output of a neural network for which the input is the original uncompressed data.
the encoder side has a pre-trained feature extraction neural network, and the encoder side has the computational, memory and power capabilities to run such feature extraction neural network.
it is possible to compute a rate loss which provides an indication of how many bits are spent to represent the original data. This can be either the exact number of bits or an approximation. Importantly, the rate loss (and all other loss terms) need to be suitable for updating the neural networks that impact the rate loss (or the other loss terms). In case the training is performed by gradient-based optimization, the rate loss (and all other loss terms) need to be differentiable with respect to the parameters of the neural networks that impact the rate loss (or the other loss terms). For example, the rate loss may be computed by a probability model that is used for predicting the probability of the next symbol to be encoded. The probability model may be a neural network. The output of the probability model may be used by an entropy-based lossless encoder (and decoder), such as by an arithmetic encoder (and decoder). Examples of neural network architectures for probability models are auto-regressive models, which use the previously predicted data to predict the probability of the current data to be encoded. One implementation of such architecture is PixelCNN.
it is possible to compute a task loss from the output of each task-NN. For example, for image classification, the cross-entropy loss may be used. For regression tasks, MSE, L1 or L2 norms may be used, and the like.

For the sake of simplicity following embodiments are explained with help of video as an example type of data. However, various embodiments are not restricted to any specific type of data. Other example types of data, include but are not limited to images, audio, audio-video, speech, and/or text.

In some embodiments, the data that is input to the encoder may be referred to as ‘original data’ or ‘original video, and is usually uncompressed or anyway high-quality.

Various embodiments propose a set of strategies for weighting the loss terms forming the training objective for an end-to-end learned video codec for machines.

### Example Embodiment 1: Training-Stage Weighting Strategies

This embodiment proposes to perform the training of the model in different steps, where at each step the weighting of the loss terms is changed. It should be noted that in some embodiments, the order of the steps may be altered or changed.

In the first step, only the MSE is used to train the neural networks of the system, for example, the neural encoder, the probability model and the neural decoder. The MSE loss is computed between the original data and the decoded data. The MSE is provided as an example. Other distortion metrics, for example, L1 norm (sum of absolute differences), L2 norm (sum of squared differences), Multi-Scale Structural Similarity Index Measure (MS-SSIM), and the like may be used instead. In this first step, multiple distortion metrics may even be combined together, with same weight or different weights. Using distortion metrics in this first step corresponds to setting a non-zero weight for the distortion metrics and a zero weight for all other loss terms.

In a second step, the weight for one or more of the other loss terms is gradually increased. For instance, the weight for one loss term can be a function of the current epoch number ‘E’: weight=10³*1.01^{E-1}. The gradual nature of the change is important in order to give the model the possibility to adapt non-abruptly, which may otherwise cause the model to diverge or not to train effectively. The more important loss terms would have their weight increased with respect to other less important loss terms, given the goal of the training session. For example, if the goal is obtaining a model which targets a bitrate, e.g. 0.01 bpp, and can afford to lose performance of the other tasks, then the rate loss' weight would increase more than other losses. This way, the gradients obtained by differentiating the total objective will be dominated by the gradients computed from the more important loss terms, which means that the more important loss terms will decrease more after using the gradients for updating the neural networks during the training process.

The learning rate, which determines the scaling of the weight-updates during the training process, should be decreased over time, in order to keep the training stable. For example, the learning rate may be reduced every E epochs (where E may be predetermined) by a fixed amount. For example, the learning rate may be reduced by 0.001% every training iteration. Another example of learning rate decay is to initially fix a temporal budget, .g., the maximum duration of the training in terms of epochs, and linearly decaying the learning rate with the number of epochs, so that at the first epoch the learning rate is the initial learning rate (which is set manually before starting the training), and at the of the last epoch the learning rate is zero. This and other learning rate decay strategies known in the literature may be applied.

In particular, following two loss weighting strategies are proposed:

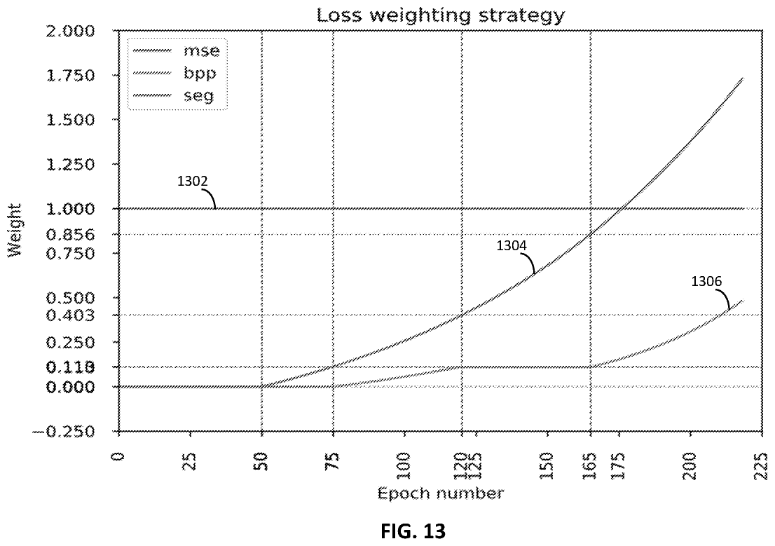

FIG. 13 illustrates an example proposed weighting strategy for the task of image segmentation, in accordance with an embodiment. This embodiment is explained with image segmentation as an example task, however, the embodiment is also applicable to other tasks, for example, object detection, object tracking, and the like. This strategy consists of 5 phases:
1st phase: This phase may range from, for example, epochs 0 to 50. In this phase, gradients come only from the MSE loss 1302 with weight=1. Other losses are weighted 0.
2nd phase: This phase may range from, for example, epochs 50 to 75. In this phase, task loss, for example, segmentation loss (seg) 1304 starts to contribute to the gradients.
3rd phase: This phase may range from, for example, epochs 76 to 120. In this phase, rate loss, measured as bits-per-pixel (bpp) 1306 is gradually introduced.
4th phase: This phase may range from, for example, epochs 121 to 165. This phase focuses on enhancing the task performance by increasing seg 1304 weight (e.g., weight for the segmentation loss), and keeping the bpp weight unchanged 1306.
5th phase: This phase may range from, for example, epochs 166 onwards. In this phase, the network is now stable, focus on searching for best trade-offs of the 2 main objectives (bpp 1306 and seg 1304). Rate-control is achieved along the way by saving checkpoints.

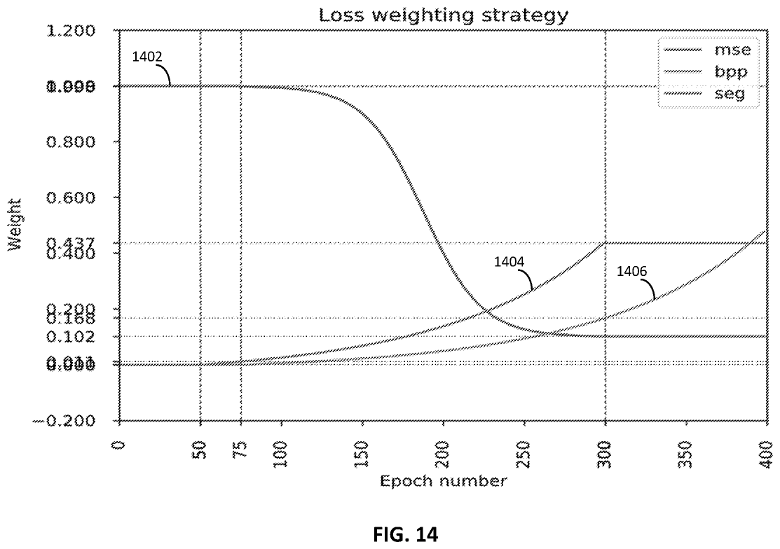

FIG. 14 illustrates a loss weighting strategy, for the task of image segmentation, in accordance with another embodiment. Similar to previous embodiment, this embodiment is also explained with image segmentation as an example task, however, the embodiment is also applicable to other tasks, for example, object detection, object tracking, and the like. In this strategy:
MSE loss 1402 dominates the gradient flow at network warm-up, then ease down its influence.
Task performance, for example, segmentation weight (seg) 1404 gets improved since after the warm-up, and then stops increasing its impact therefore leaves room for the bitrate improvement.
Bpp loss weight 1406 gradually grows till the end, pushing for the best bitrate on an acceptable task performance

To illustrate the effectiveness of the proposed loss weighting strategies, experiments were performed for the task of instance segmentation in images from the CityScapes dataset, using MaskRCNN as the task-NN. For these experiments, the first of the two above mentioned strategies as illustrated in FIGS. 13 and 14 were used. The performance of a strategy is evaluated against versatile video codec (VVC), which was recently finalized within JVET standardization activities.

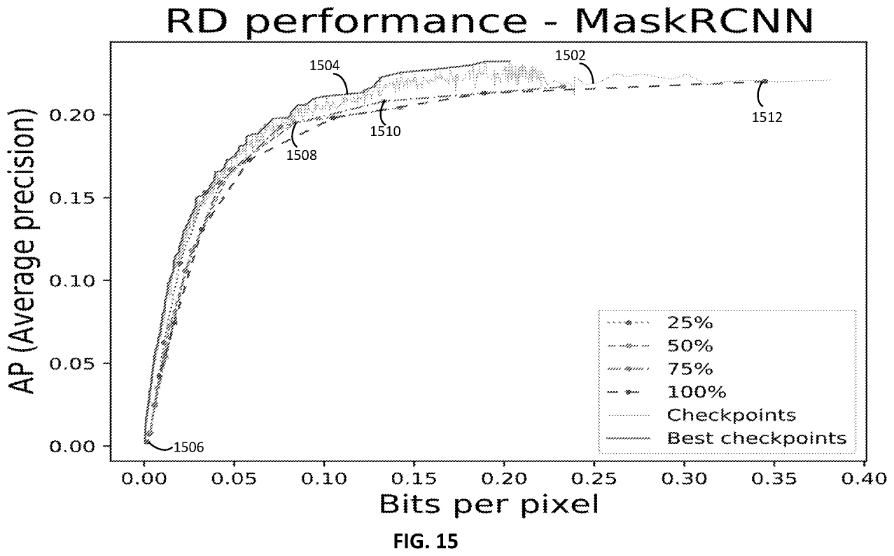

FIG. 15 illustrates the rate-distortion performance comparison, in accordance with an embodiment. Instead of a distortion, average precision (ap) is used as a measure of the task performance, which an example of segmentation task, and as a measure of rate bits per pixel is used.

Every point on the checkpoints curve 1502 is the performance of the model on the evaluation dataset after an iteration (epoch) of training.

Best checkpoints 1504 are the checkpoints that provide the best task performance in a bitrate range. The points labeled as 25%, for example, points 1506, 50%, for example, points 1508, 75%, for, points 1510, and 100%, for example, points 1512 are the VVC anchors. Each percentage value refers to the image resolution of the input to the VVC encoder and of the output of the VVC decoder. After decoding, the decoded image is upscaled to the original resolution. The reason for using different resolutions is that task-NNs (and more in general computer vision tasks) are robust to the amount of detail contained in the input images, thus images can be downsampled without losing too much task performance The resolution change illustrates that even by performing such resolution optimization for the input to VVC, the proposed strategies provide better results as compared to the VVC anchors. In order to obtain multiple bitrate points for the VVC anchors, in addition to varying the input resolution, quantization parameter (QP) of VVC are also changed.

As illustrated in FIG. 15, the Best checkpoints 1504, obtained by the end-to-end learned codec trained using proposed strategy, performs better than the VVC anchors.

### Example Embodiment 2: Inference-Time Optimization in Video Coding for Machines

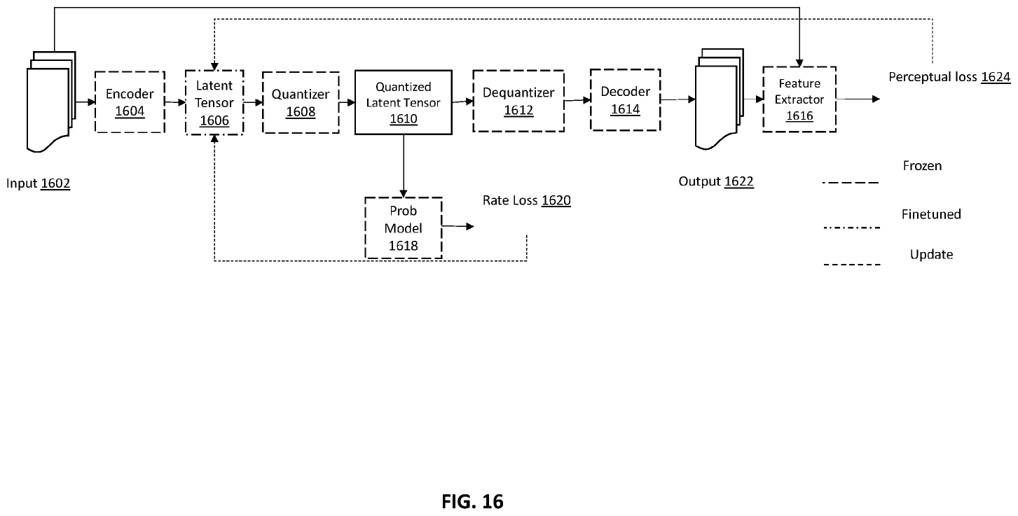

FIG. 16 illustrates inference-time optimization in video coding for machines, in accordance with an embodiment. In this embodiment proposes a set of loss terms to be used for inference time optimization, and a loss-weighting strategy to be used for these loss terms.

Inference time optimization refers to an encoder-side optimization process which occurs when the encoder needs to compress a given input video. The optimization is content-specific, e.g., it is based on the given input video to be compressed. In particular, the goal is to adapt the data which is output by the encoder neural network so that the rate-distortion performance is improved, e.g., the rate-distortion trade-off is better than when using a normal inference process which is based on a simple forward operation through the neural networks.

There are multiple possible implementations of encoder-side optimization in end-to-end learned codecs. One such implementation is to optimize the encoder neural network. Another such implementation is to optimize the latent tensor. This embodiment, considers the latter case of optimizing the latent tensor. The inference-stage thus consists of the following steps:
The video is input 1602 to a neural network encoder 1604.
The neural network encoder 1604 outputs an initial version of a latent tensor 1606.
The initial version of the latent tensor 1606 may be input to a quantizer 1608 or to an approximation of a quantizer.
The output of the quantizer 1608 is a quantized latent tensor 1610, which may be input to a probability model 1618 that may be used as part of the lossless codec. An output of the probability model 1618 is used to compute a rate loss 1620. Also, the quantized latent tensor 1610 may be input to a dequantizer 1612, and the dequantized data output by the dequnatizer 1612 may be input to a decoder neural network 1614, to obtain an output 1622.
A feature extraction may be performed by a feature extractor 1616 on the output 1622. Also, a feature extraction may be performed by the feature extractor 1616 on the input 1602. The features obtained from the output 1622 and from the input are used for computing a perceptual loss 1624.
The perceptual loss 1624 and the rate loss 1620 may be differentiated with respect to the latent tensor 1606, which results into computing gradients of the two losses with respect to the latent tensor 1606.
An optimization process is started, where the latent tensor is iteratively adapted, for example by using the computed gradients, via a gradient-based optimization.
The core of this embodiment is on what loss terms to use for this latent tensor optimization and how to weight the different loss terms.

The encoder device 1604 is assumed not to have the task-NN that will be used at decoder-side. However, common computer vision tasks are based on the extraction of high-level semantics such as segmenting objects, detecting the location of objects, determining the category of objects, determining the action or activity of people, and the like. These tasks are performed by extracting first low level features from data, then intermediate level features from the low level features, then high-level features from intermediate level features, and finally making a decision about the high-level semantics. Low-level features and intermediate level features are usually common to many tasks. Thus, this embodiment proposes to use, at an encoder side, a pretrained feature-extraction neural network, in order to first extract low level and intermediate level features from the original data and from the decoded data (the encoder is assumed to have also the decoder part), and then to compute a distortion metric between the features from the original data and from the decoded data. The distortion metric may be L1 , L2, and the like, or a linear combination of multiple distortion metrics. Such a distortion metric may be referred to as perceptual loss.

In this embodiment, a perceptual loss is used as a proxy for the task loss, which is not available at encoder-side during inference time.

In some embodiments, the perceptual loss comprises feature distortion, for example, a distortion metric computed on the features extracted from an original data and an decoded data.

In alternate or additional implementation of this embodiment, the encoder device may use the encoder neural network itself as a feature extractor. The original data and the decoded data are input to the encoder neural network, and one or more distortion metrics are computed from the features extracted from one or more layers of the encoder neural network.

The initial version of the latent tensor is updated to minimize the weighted sum of rate loss, perceptual loss and optionally other losses (e.g. MSE, MS-SSIM) between input and output of the codec.

In some cases, the initial version of the latent tensor may be randomly initialized instead of being the encoded representation of the input.

The embodiment described above is validated with the help of following experiments. A VGG-16 neural network is used as the pretrained feature extractor. The perceptual loss is the MSE of the feature maps produced at the 2nd and 4th Max Pooling layers. The proposed embodiment optimized the latent tensor for 30 iterations, using CityScapes dataset and MaskRCNN as the task-NN (for instance segmentation).

The results of the experiment are reported in the following table, where two neural network based codecs for machines are compared: a base codec which is run or executed in a traditional way, e.g., a single forward operation through all the blocks of the codec's pipeline, and a Finetuned model which is the codec obtained by the proposed embodiment. The table reports two cases: a high bitrate case and a low bitrate case. For each of these cases and for each codec, the table reports the bitrate in terms of bits per pixel (bpp) and the average precision (ap). Considering the high bitrate case, for the Finetuned codec, the bpp is lower and the ap is higher, compared to the Base codec, which means that the Finetuned codec performs better than the Base codec both in terms of bitrate and in terms of tasks performance Considering the low bitrate case, for the Finetuned codec, the bpp is lower and the ap is same, compared to the Base codec, which means that the Finetuned codec performs better than the Based model in terms of bitrate at equal task performance.

| | Hi bitrate | Low bitrate |
|---|---|---|
| | Bitrate - Task performance | BPP - Task Performance |
| Base | BPP: 0.301 - AP: 0.209 | BPP: 0.054 - AP: 0.162 |
| Finetuned | BPP: 0.282 - AP: 0.222 | BPP: 0.052 - AP: 0.162 |

### Additional Embodiment: Alternate Minimization

As an additional strategy for loss weighting problem in example embodiment 1, a loss calibration strategy that automatically balances the losses by giving a tolerance value for loss variance of each loss term is proposed. For example, given two loss terms Loss1, Loss2 with respect to two objectives of the training; t1, t2 are the tolerance values for Loss1,Loss2; the calibration can be done in an alternate optimization fashion in the following steps:
Disable gradients with respect to Loss1, e.g. weight for Loss 1 is set to 0, whereas weight for Loss2 is set to 1
Minimize Loss2 until the tolerance of Loss1 is violated, e.g. var(Loss1)>t1, where var(Loss1) is a function that returns the variance of Loss1.
Switch the roles of Loss1 and Loss2, and repeat the above steps.
Stop if a stopping condition, e.g. enough number of iterations, is fulfilled.

The strategy could be combined with the initial embodiment using MSE as warm-up, e.g., first perform the warm-up step, then apply this strategy. Also, this strategy may be applied after any multi-task training stage. Other metrics than loss variance could be introduced as tolerance value, e.g. the loss values themselves. The scheme could be scaled to multiple loss functions, where for example Loss1 a linear combination of more important loss terms (even just one loss term) and Loss2 is a linear combination of less important loss terms.

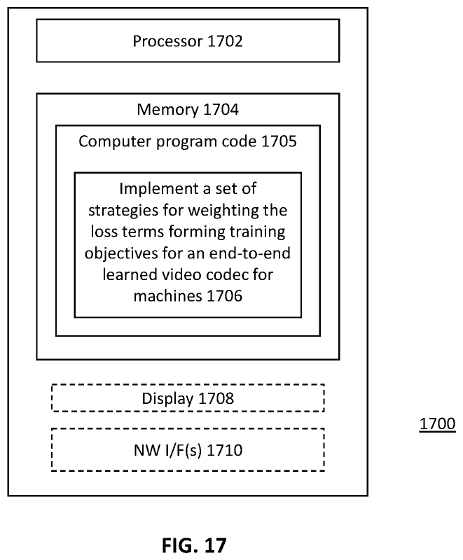

FIG. 17 is an example apparatus 1700, which may be implemented in hardware, configured to implement a set of strategies for weighting the loss terms forming training objectives for an end-to-end learned video codec for machines, based on the examples described herein. The apparatus 1700 comprises a processor 1702, at least one non-transitory memory 1704 including computer program code 1705, wherein the at least one memory 1704 and the computer program code 1705 are configured to, with the at least one processor 1702, cause the apparatus implement a set of strategies for weighting the loss terms forming training objectives for an end-to-end learned video codec for machines 1706. The apparatus 1700 optionally includes a display 1708 that may be used to display content during rendering. The apparatus 1700 optionally includes one or more network (NW) interfaces (I/F(s)) 1710. The NW I/F(s) 1710 may be wired and/or wireless and communicate over the Internet/other network(s) via any communication technique. The NW I/F(s) 1710 may comprise one or more transmitters and one or more receivers.

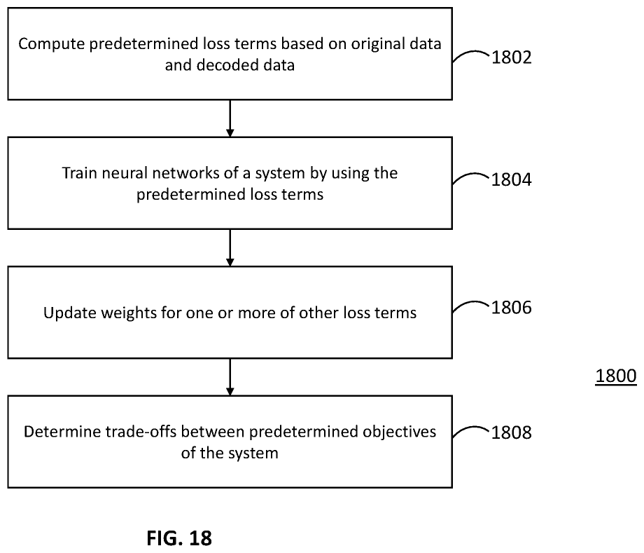

FIG. 18 is an example method 1800 to implement a set of strategies for weighting the loss terms forming training objectives for an end-to-end learned video codec for machines, in accordance with an embodiment. As shown in FIG. 17, the apparatus 1700 includes means, such as the processing circuitry 1702 or the like, for implementing a set of strategies for weighting the loss terms forming training objectives for an end-to-end learned video codec for machines. At 1802, the method includes computing predetermined loss terms based on original data and decoded data. At 1804, the method includes training neural networks of a system by using the predetermined loss terms. At 1806, the method includes updating weights for one or more of other loss terms. At step 1808, the method includes determining trade-offs between predetermined objectives of the system.

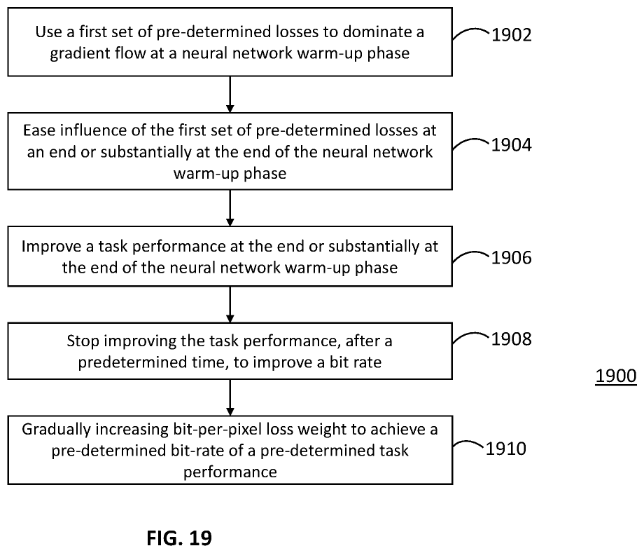

FIG. 19 is an example method 1900 to implement a set of strategies for weighting the loss terms forming training objectives for an end-to-end learned video codec for machines, in accordance with another embodiment. As shown in FIG. 17, the apparatus 1700 includes means, such as the processing circuitry 1702 or the like, for implementing a set of strategies for weighting the loss terms forming training objectives for an end-to-end learned video codec for machines. At 1902, the method includes using a first set of pre-determined losses to dominate a gradient flow at a neural network warm-up phase. At 1904, the method includes training neural networks of a system by using the predetermined loss terms. At 1906, the method includes improving a task performance at the end or substantially at the end of the neural network warm-up phase. At step 1908, the method includes stopping improving the task performance, after a predetermined time, to decrease a bit rate loss. At step 1910, the method includes gradually increasing a weight of bit rate loss to achieve a pre-determined bit-rate or a pre-determined task performance.

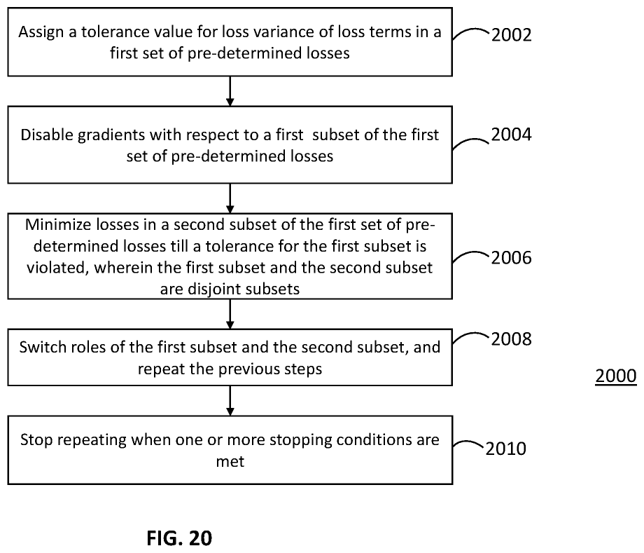

FIG. 20 is an example method 2000 to implement a loss calibration strategy to balance losses, in accordance with an embodiment. As shown in FIG. 7 or FIG. 17, the apparatus 700 or apparatus 1700 includes means, such as the processing circuitry 702 or 1702 or the like, for implementing a loss calibration strategy to balance losses, in accordance with an embodiment. At 2002, the method includes assigning a tolerance value for loss variance of loss terms in a first set of pre-determined losses. At 2004, the method includes disabling gradients with respect to a first subset of the first set of pre-determined losses. At 2006, the method includes minimizing losses in a second subset of the first set of pre-determined losses till a tolerance for the first subset is violated. The first subset and the second subset are disjoint subsets. At step 2008, the method includes switching roles of the first subset and the second subset and repeat 2002, 2004, and 2006. At step 2010, the method includes stop repeating when one or more stopping conditions are met.

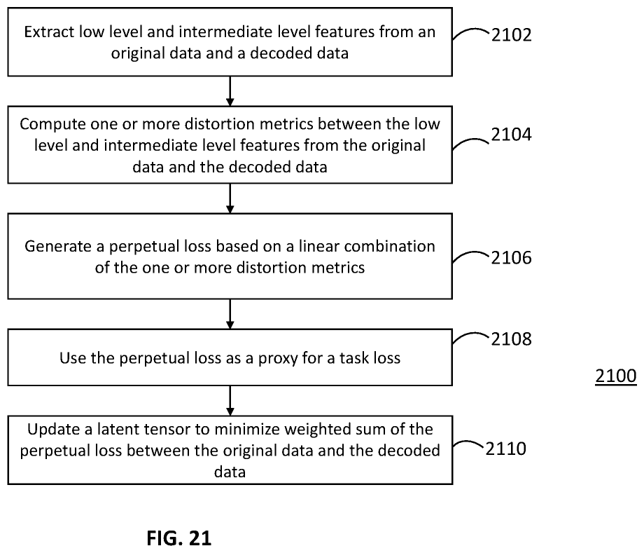

FIG. 21 is an example method 2100 to implement inference-time optimization, in accordance with an embodiment. As shown in FIG. 7 or FIG. 17, the apparatus 700 or apparatus 1700 includes means, such as the processing circuitry 702 or 1702 or the like, to implement inference-time optimization, in accordance with an embodiment, in accordance with an embodiment. At 2102, the method includes extracting low level and intermediate level features from an original data and a decoded data. At 2104, the method includes computing one or more distortion metrics between the low level and intermediate level features from the original data and the decoded data. At 2106, the method includes generating a perceptual loss based on a linear combination of the one or more distortion metrics. At step 2108, the method includes using the perceptual loss as a proxy for a task loss. At step 2110, the method includes updating an initial version of a latent tensor to minimize weighted sum of the perceptual loss between the original data and the decoded data.

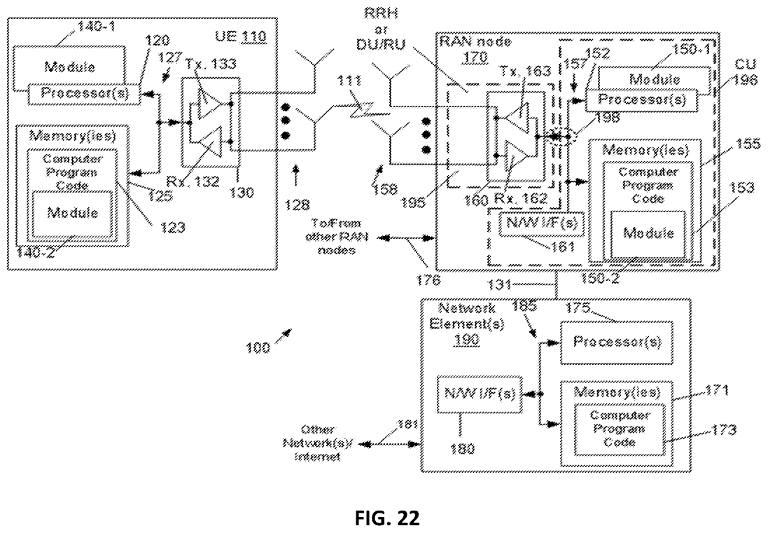

Turning to FIG. 22, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, for example, as part of a RU, but some examples of this may have the transceiver 160 as part of a separate RU, for example, under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, for example, link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (for example, a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (for example, the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the network element(s) 190, and note that both 5G and LTE functions might be supported. The RAN node 170 is coupled via a link 131 to the network element 190. The link 131 may be implemented as, for example, an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

One or more of modules 140-1, 140-2, 150-1, and 150-2 may be configured to implement a set of strategies for weighting the loss terms forming training objectives for an end-to-end learned video codec for machines. Computer program code 173 may also be configured to implement y a set of strategies for weighting the loss terms forming training objectives for an end-to-end learned video codec for machines.

As described above, FIGS. 18 to 21 include flowcharts of an apparatus (e.g. 50, 100, 700 or 1700), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g. 58, 125, 704, or 1704) of an apparatus employing embodiments of the invention and executed by processing circuitry (e.g. 56, 120, 702, or 1702) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowcharts of FIGS. 18 to 21. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1-46. (canceled)

47. An apparatus comprising:
at least one processor; and
at least one non-transitory memory including computer program code;
wherein the at least one memory and the computer program code are configured to, with the at least one processor, cause the apparatus at least to perform:
compute predetermined loss terms based on original data and decoded data;
train one or more neural networks of a system by using predetermined loss terms;
update weights for one or more of other loss terms; and
determine trade-offs between predetermined objectives of the system.

48. The apparatus of claim 47, wherein the predetermined loss terms and the other loss terms comprise one or more distortion metrics.

49. The apparatus of claim 48, wherein the one or more distortion metrics comprise mean squared error (MSE) losses, a sum of absolute differences (L1 norm), a sum of squared differences (L2 norm), or a multi-scale structural similarity index measure (MS-SSIM).

50. The apparatus of claim 49, wherein the apparatus is further caused to combine one or more metrics with same or different weights.

51. The apparatus of claim 47, wherein the one or more neural networks of the system comprises one or more of a neural network encoder, a neural network decoder, or a probability model.

52. The apparatus of claim 49, wherein the apparatus is further caused to:
set a non-zero weight for the predetermined loss terms; and
set a zero weight for the one or more of the other loss terms.

53. The apparatus of claim 47, wherein the one or more of the other loss terms do not comprise the predetermined loss terms.

54. The apparatus of claim 47, wherein the weights for one or more other losses are changed gradually in order to adapt the one or more neural networks non-abruptly.

55. The apparatus of claim 47, wherein the weights for one or more other losses are changed based on a priority of the one or more other losses.

56. An apparatus comprising:
at least one processor; and
at least one non-transitory memory including computer program code;
wherein the at least one memory and the computer program code are configured to, with the at least one processor, cause the apparatus at least to perform:
use a first set of pre-determined losses to dominate a gradient flow at a neural network warm-up phase;
ease influence of the first set of pre-determined losses at an end or substantially at the end of the neural network warm-up phase;
improve a task performance at the end or substantially at the end of the neural network warm-up phase;
stop improving the task performance, after a predetermined time, to decrease a bit rate loss; and
gradually increase a weight of the bit rate loss to achieve a pre-determined bit-rate or a pre-determined task performance.

57. The apparatus of claim 56, wherein the apparatus is further caused to assign a tolerance value for a loss variance of each loss term in the first set of pre-determined losses.

58. An apparatus comprising:
at least one processor; and
at least one non-transitory memory including computer program code;
wherein the at least one memory and the computer program code are configured to, with the at least one processor, cause the apparatus at least to perform:
assign a tolerance value for loss variance of loss terms in a first set of pre-determined losses;
disable gradients with respect to a first subset of the first set of pre-determined losses;
minimize losses in a second subset of the first set of pre-determined losses till a tolerance for the first subset is violated, wherein the first subset and the second subset are disjoint subsets;
switch roles of the first subset and the second subset, and repeat the previous steps; and
stop repeating when one or more stopping conditions are met.

59. An apparatus comprising:
at least one processor; and
at least one non-transitory memory including computer program code;
wherein the at least one memory and the computer program code are configured to, with the at least one processor, cause the apparatus at least to perform:
extract low level and intermediate level features from an original data and a decoded data;
compute one or more distortion metrics between the low level and intermediate level features from the original data and the decoded data;
generate a perceptual loss based on a linear combination of one or more distortion metrics;
use the perceptual loss as a proxy for a task loss;
update an initial version of a latent tensor to minimize a weighted sum of the perceptual loss between the original data and the decoded data.

60. The apparatus of claim 59, wherein the apparatus is further caused to output the initial version of the latent tensor, wherein the latent tensor is an encoded representation of the original data.

61. The apparatus of claim 59, wherein the apparatus is further caused to update the initial version of the latent tensor to minimize one or more of a weighted sum of a rate loss, a mean squared error loss, or a multi-scale structural similarity index measure.

62. A method comprising:
computing predetermined loss terms based on original data and decoded data;
training one or more neural networks of a system by using predetermined loss terms;
updating weights for one or more of other loss terms; and
determining trade-offs between predetermined objectives of the system.

63. The method of claim 62, wherein the predetermined loss terms and other loss terms comprise one or more distortion metrics.

64. The method of claim 62, wherein the one or more neural networks of the system comprises one or more of a neural network encoder, a neural network decoder, or a probability model.

65. The method of claim 62, wherein the one or more of the other loss terms do not comprise the predetermined loss terms.

66. The method of claim 62, wherein the weights for one or more other losses are changed gradually in order to adapt the one or more neural networks non-abruptly.
